(19) United States
(12) Patent Application Publication
(10) Pub. No.: US 2010/0127441 A1
(43) Pub. Date: May 27, 2010

(54) Frequency Decoupling Device and Hydro-Elastic Articulation Including a Liquid Chamber having a Reduced Thickness

(75) Inventors: Franck Honneur, Clermont-Ferrand (FR); François-Xavier Bruneau, Beauregard Vendon (FR); Philippe Souyri, Saint Genes Du Retz (FR)

Correspondence Address: COHEN, PONTANI, LIEBERMAN & PAVANE LLP, 551 FIFTH AVENUE, SUITE 1210, NEW YORK, NY, 10176, US

(73) Assignee: MICHELIN RECHERCHE ET TECHNIQUE S.A., Granges-Paccot (CH)

(21) Appl. No.: 12/520,847

(22) PCT Filed: Dec. 20, 2007
(86) PCT No.: PCT/EP2007/011268

§ 371 Date: Jan. 19, 2010

(30) Foreign Application Priority Data
Dec. 20, 2006 (FR) 0611230

(51) Int. Cl. F16F 13/14

(52) U.S. Cl. 267/140.13

(57) ABSTRACT

A frequency decoupling device for decoupling a first part with respect to a second part. The device comprises a rigid outer sleeve (1) which is adapted to be secured to the first part and, positioned inside the outer sleeve, a rigid inner sleeve (2) which is adapted to be secured to the second part, an elastically deformable element (3, 4, 10) being interposed between the sleeves so as to form between the sleeves at least one annular chamber (5) containing a liquid. With the chamber having an inner perimeter “Pᵢₙₜ”, a mean height “H” on the perimeter and a mean thickness “E” on the perimeter, the mean thickness E satisfies the following condition:

$$E \leq \frac{{( {P}_{int} / 2 π )}^{3}}{200000} \times H ,$$

the inner perimeter Pᵢₙₜ, the mean height H and the mean thickness E being expressed in millimeters.

The invention relates to a frequency decoupling device for decoupling a first part with respect to a second part, and to a hydro-elastic joint comprising such a frequency decoupling device.

The invention finds a particular application in the field of automotive vehicles, particularly in the context of the ground-contact systems of such vehicles. In particular, the hydro-elastic joint may form a ball end of a wishbone of a front axle assembly of a motor vehicle, the main function of which is to maintain the wheel plane.

Specifically, the ground contact has to be achieved through the agency of frequency decoupling devices which are designed to filter out the road noise, the said devices being interposed between the suspension of the vehicle and the chassis thereof.

To do this, it is known practice to use hydro-elastic joints which, depending on their inherent characteristics, provide:
sufficient guidance through their static stiffnesses;
suspension travel by accepting linear, torsional or conical deflections; and
vibration insulation through their dynamic stiffness lows.

According to the anticipated applications, there are a great many configurations of hydro-elastic joints known which are designed to perform the aforementioned three functions.

However, none of the known configurations is able to combine dynamic and static stiffness values which are designed to perform these functions in a filtering range of between 180 Hz and 800 Hz. Now, driving generates in this frequency range noises known as “macro roughness” noises that need therefore to be filtered out satisfactorily without deteriorating the guidance and deflection functions of the hydro-elastic joint.

In addition, the complexity of the devices of the prior art mean that their cost of manufacture is very high, thus limiting their use in the automotive field.

The invention aims to address the problems of the prior art by proposing a frequency decoupling device, particularly one that operates in a frequency range of between 180 Hz and 800 Hz, and a hydro-elastic joint that is able to provide guidance, deflection and filtering in such a frequency range.

To this end, and according to a first aspect, the invention proposes a frequency decoupling device for decoupling a first part with respect to a second part, the said device comprising a rigid outer sleeve which is intended to be secured to the first part and, positioned inside the said outer sleeve, a rigid inner sleeve which is intended to be secured to the second part, an elastically deformable element being interposed between the said sleeves so as to form between the said sleeves at least one annular chamber containing a liquid, the said device being characterized in that, with the chamber being of a small thickness, the elastically deformable element comprises an upper ring and a lower ring which axially delimit the chamber, respectively forming seals for the said chamber.

For preference, the said chamber has an interior perimeter “Pᵢₙₜ”, a mean height “H” on the said perimeter and a mean thickness “E” on the said perimeter, the mean thickness E satisfies the following condition:

$$E \leq \frac{{( {P}_{int} / 2 π )}^{3}}{200000} \times H ,$$

the interior perimeter Pᵢₙₜ, the mean height H and the mean thickness E being expressed in millimetres.

For preference, the annular chamber exhibits symmetry of revolution or is of a cylindrical shape or in the shape of a cylinder with symmetry of revolution.

For preference, the mean thickness E of the chamber is less than 4 mm, and notably ranges between 0.5 mm and 2 mm.

For preference, the thickness of the elastically deformable element is equal to the thickness E of the chamber.

For preference, the chamber is provided radially facing a respective axial wall of each of the sleeves.

For preference, the elastically deformable element further comprises an intermediate ring which, with the upper and lower rings respectively, delimits two spaces in the liquid chamber, the said intermediate ring being discontinuous so as to form passages for liquid between the two spaces.

For preference, the upper ring and/or the lower ring has at least one wave extending inside the chamber. Again for preference, the upper ring comprises two waves which are symmetric with respect to a longitudinal plane of the chamber, two waves being provided on the lower ring, these being positioned facing a respective wave of the upper ring.

According to an alternative form of the invention, the chamber has the geometry of a cone with symmetry of revolution.

For preference, the elastically deformable element is overmoulded onto the inner sleeve. Alternatively, the upper and/or lower rings are attached to the inner sleeve.

According to one embodiment of the invention, the volume of the chamber is at least partially formed by a deformation of the outer sleeve.

According to a second aspect, the invention proposes a hydro-elastic joint comprising such a frequency decoupling device, the said joint comprising a rigid member which is positioned inside the inner sleeve, the said member being associated with the said sleeve via an elastically deformable body.

Other objects and advantages of the invention will become apparent from the description which follows, given with reference to the attached figures in which:

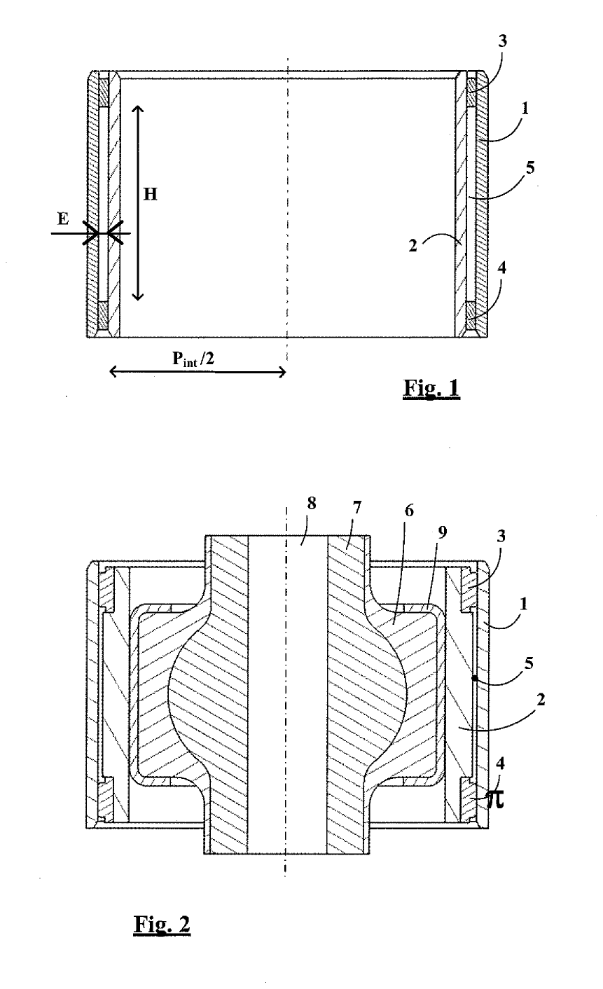

FIG. 1 is a view in longitudinal section of a frequency decoupling device according to one embodiment of the invention;

FIG. 2 is a view in longitudinal section of a hydro-elastic joint according to a first embodiment of the invention;

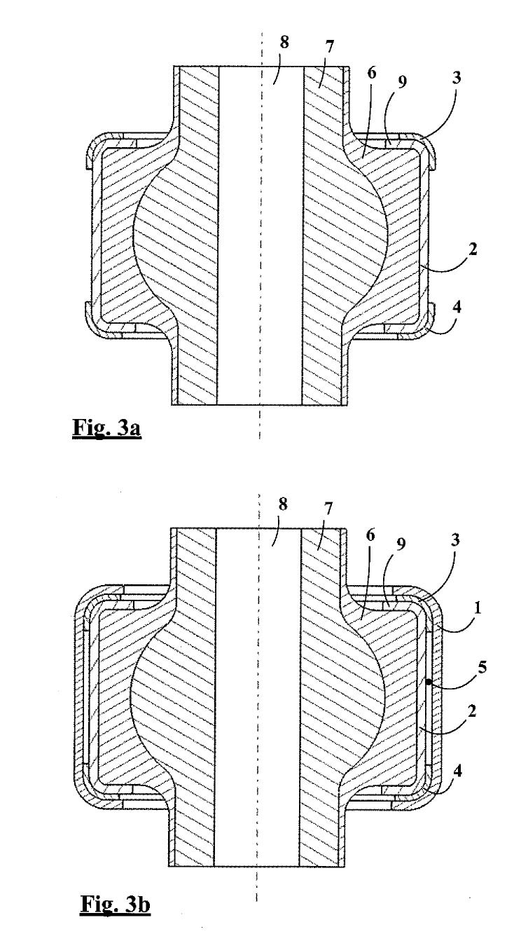

FIG. 3 are views in longitudinal section of a hydro-elastic joint according to a second embodiment of the invention, respectively before (FIG. 3a) and after (FIG. 3b) the outer sleeve has been assembled;

FIG. 4 are views of a hydro-elastic joint according to a first alternative form of the embodiment of FIG. 3, respectively in longitudinal section (FIG. 4a) and in perspective without the outer sleeve (FIG. 4b);

FIG. 5 is a perspective view of a hydro-elastic joint according to a second alternative form of the embodiment of FIG. 3, in which the outer sleeve has not been depicted;

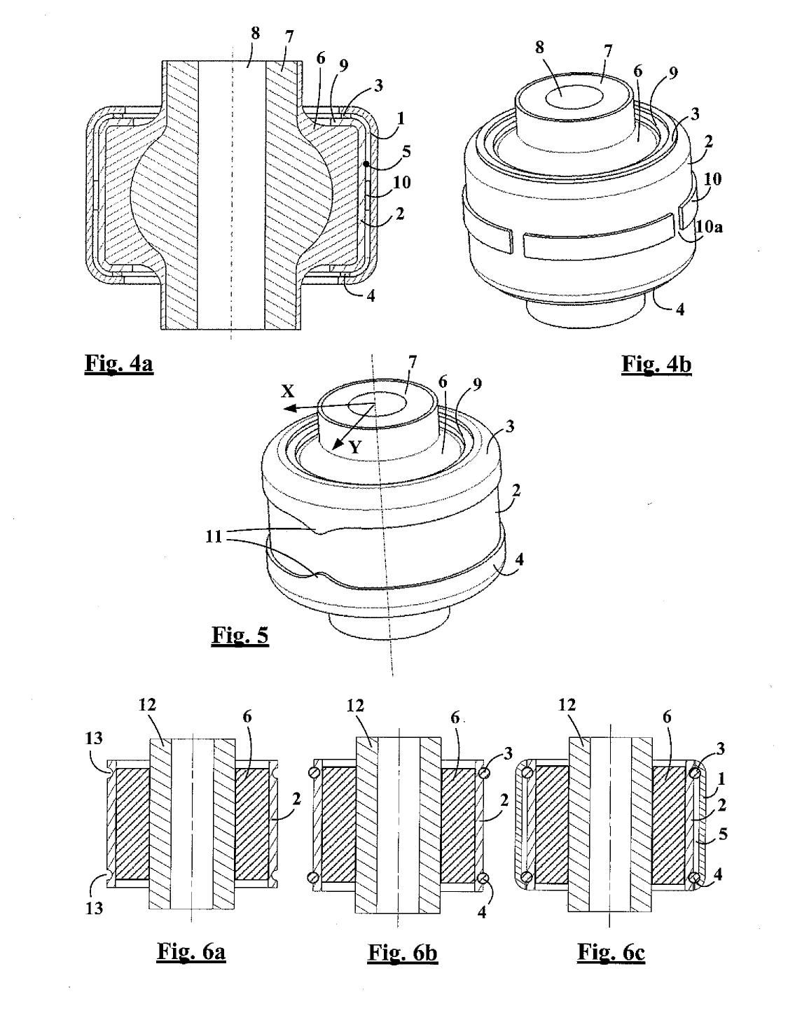

FIG. 6 are views in longitudinal section of a hydro-elastic joint according to a third embodiment of the invention, respectively before the fitting of the elastically deformable element (FIG. 6a), after the fitting of the elastically deformable element (FIG. 6b) and after the fitting of the outer sleeve (FIG. 6c);

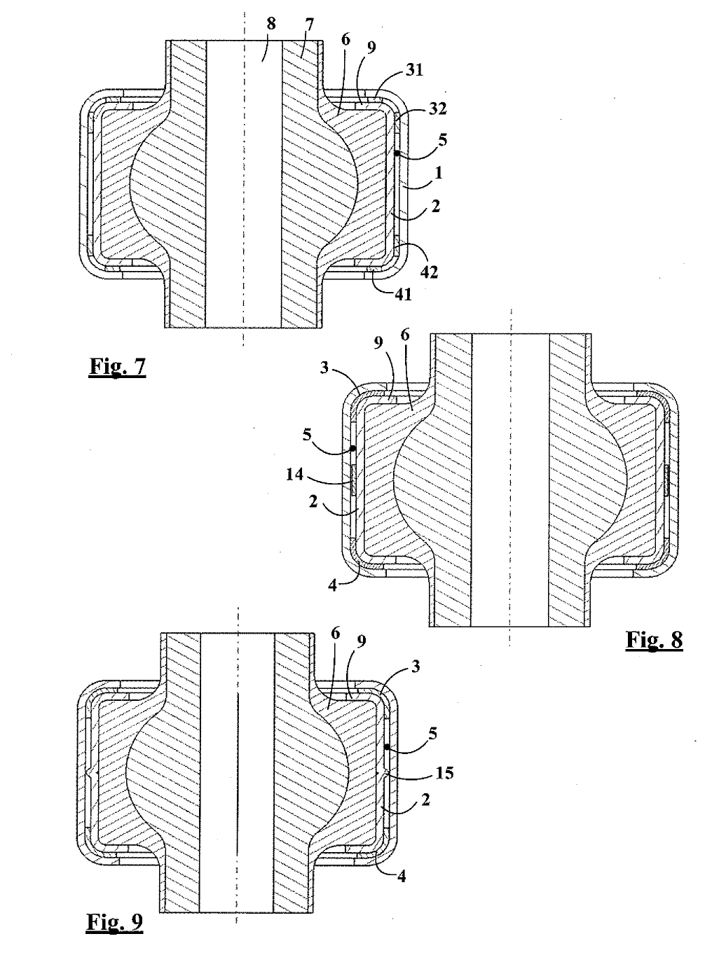

FIG. 7 is a view in longitudinal section of a hydro-elastic joint according to a fourth embodiment of the invention;

FIGS. 8 and 9 are views in longitudinal section of a hydro-elastic joint incorporating a radial stop according to a fifth and a sixth embodiment of the invention, respectively;

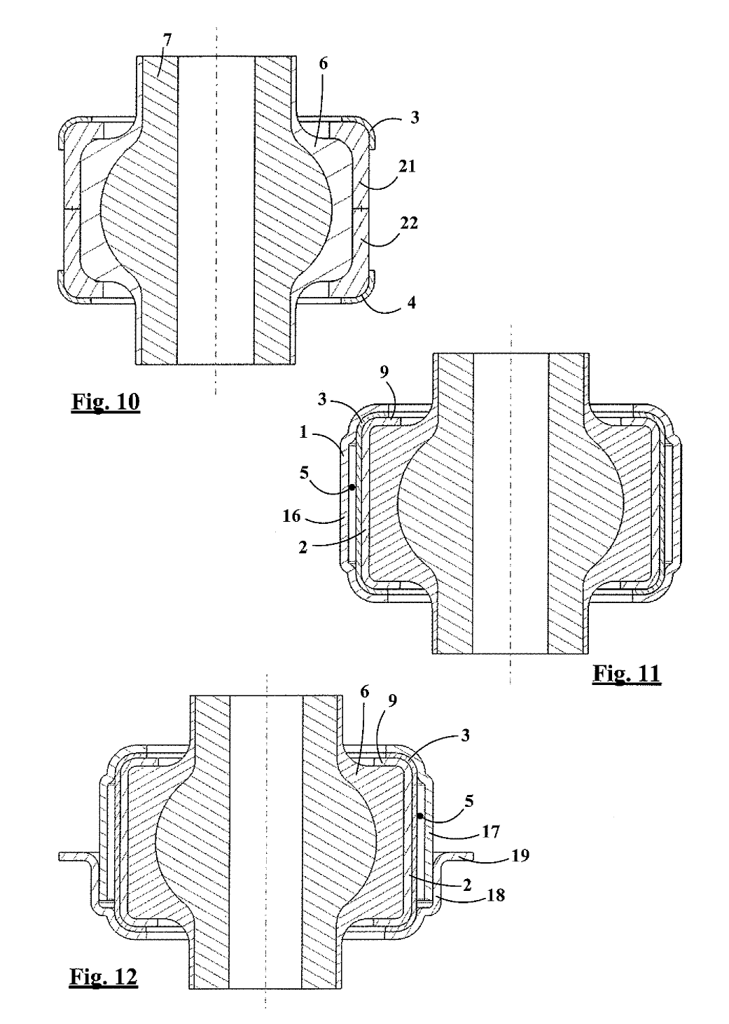

FIG. 10 is a view in longitudinal section of a hydro-elastic joint according to a seventh embodiment of the invention;

FIG. 11 is a view in longitudinal section of a hydro-elastic joint according to an eighth embodiment of the invention;

FIG. 12 is a view in longitudinal section of a hydro-elastic joint according to a ninth embodiment of the invention;

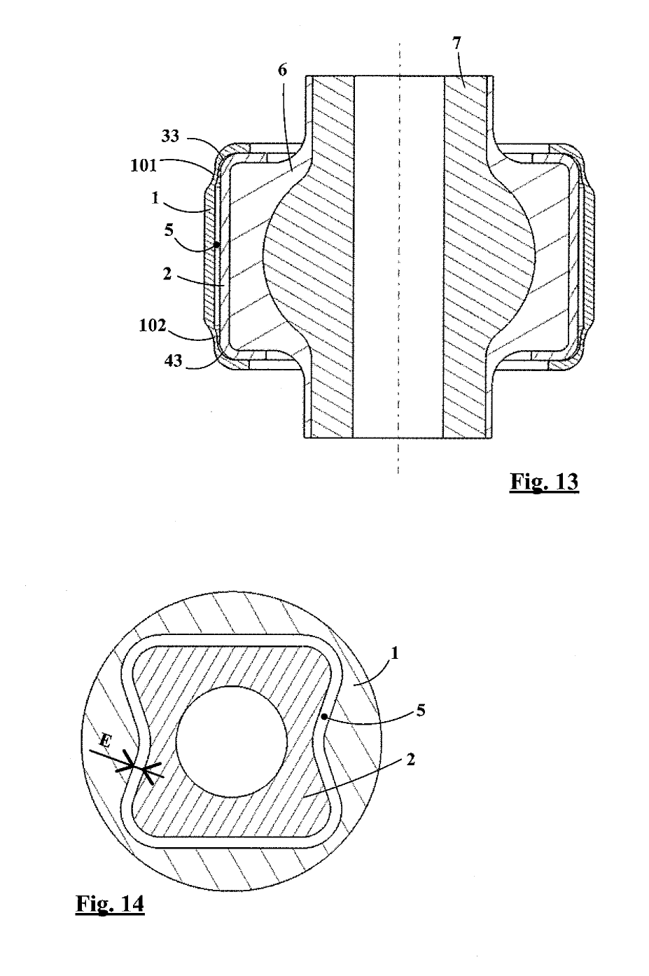

FIG. 13 is a view in longitudinal section of a hydro-elastic joint according to a tenth embodiment of the invention;

FIG. 14 is a view in axial section of a frequency decoupling device according to an alternative form of embodiment of the invention;

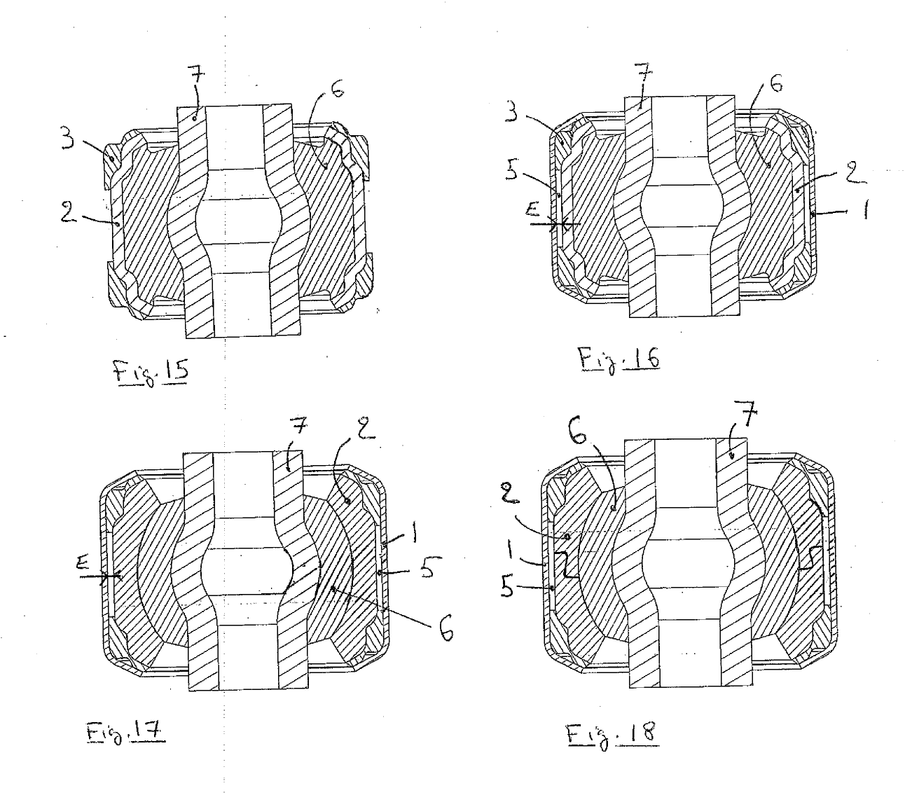

FIG. 15 is a view in longitudinal section of a hydro-elastic joint according to an eleventh embodiment of the invention in which the outer sleeve has not yet been assembled;

FIG. 16 is a view in longitudinal section of the joint of FIG. 15, fully assembled;

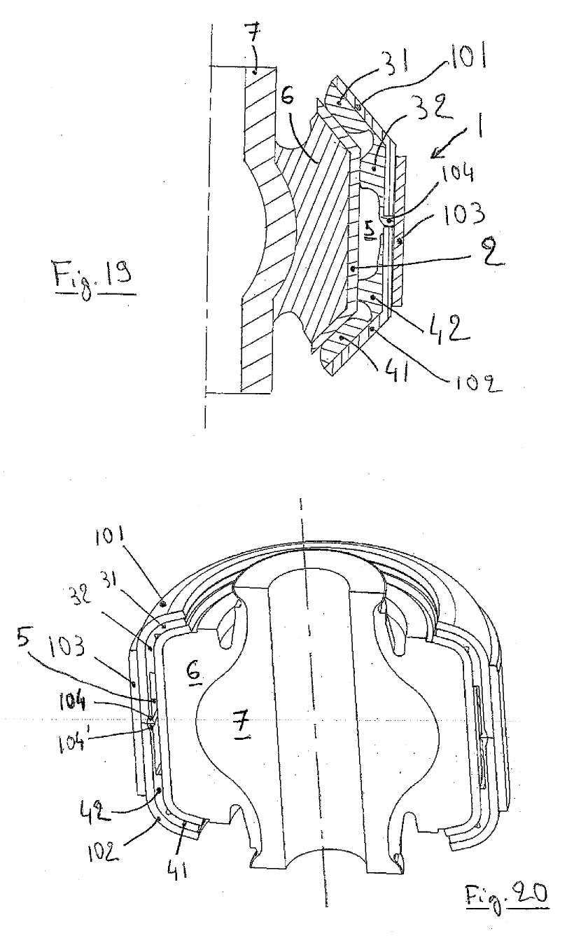

FIG. 17 is a view in longitudinal section of a hydro-elastic joint according to a twelfth embodiment of the invention;

FIG. 18 is a view in longitudinal section of an alternative form of the joint of FIG. 17;

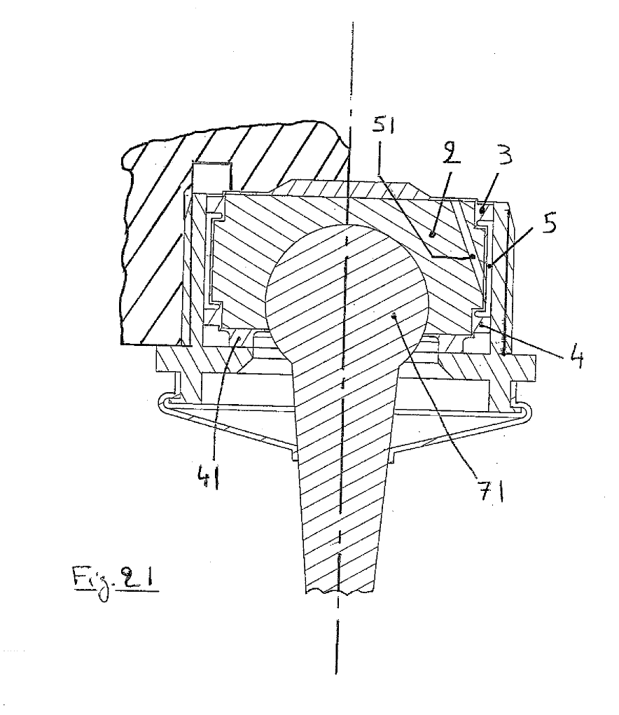

FIG. 19 is a schematic longitudinal half-section of a hydro-elastic joint according to a thirteenth embodiment of the invention;

FIG. 20 is a view in longitudinal section and in perspective of a hydro-elastic joint according to a fourteenth embodiment of the invention;

FIG. 21 is a view in longitudinal section of a hydro-elastic joint according to a fifteenth embodiment of the invention.

A frequency decoupling device for decoupling a first part with respect to a second part is described hereinbelow in conjunction with FIG. 1. According to one anticipated application, the first part is a motor vehicle suspension member and the second part is a suspended chassis member of the said vehicle. Thus, the frequency decoupling device is able to filter out vehicle road noise so as to isolate the cabin of the said vehicle by limiting the transmission of the said noise.

The decoupling device comprises a rigid outer sleeve 1 which is intended to be secured to the first part and, positioned inside the said outer sleeve, a rigid inner sleeve 2 which is intended to be secured to the second part. In FIG. 1, the sleeves 1, 2 are parts, particularly made of metal or of plastic, possibly reinforced plastic, which here have the geometry of a cylinder exhibiting symmetry of revolution, the said sleeves being positioned coaxially one around the other, with a gap “E” between them.

The frequency decoupling device further comprises an elastically deformable element which is interposed between the sleeves 1, 2, the said element being made of an elastic material chosen to suit the intended application, and may notably be formed of an elastomeric material.

In FIG. 1, the elastically deformable element comprises an upper ring 3 and a lower ring 4 which are spaced apart axially so as to delimit a chamber 5 that is a cylinder with symmetry of revolution between the sleeves 1, 2. Further, because of the elasticity of the material of the deformable element and because it is arranged compressed between the sleeves 1, 2, the rings 3, 4 form seals. Thus, the proposed arrangement allows a non-compressible liquid to be sealed inside the said chamber.

The rings 3, 4 are arranged, particularly by overmoulding onto the inner sleeve 2, respectively near an edge of the sleeves 1, 2. When the rings are overmoulded (this is also known as “bonded”) onto the inner sleeve 2, they are clamped against the outer sleeve. Naturally, the reverse is possible. Furthermore, the chamber 5 is formed facing substantially the entire periphery of the inner sleeve 2. Thus, the liquid chamber 5 is provided radially facing the respective axial wall of each of the sleeves 1, 2.

In the known way, combining an elastically deformable element with a liquid chamber 5 makes it possible to obtain a hydro-elastic-type behaviour which allows frequency decoupling, the said hydro-elastic behaviour being particularly characterized by:
static stiffness;
dynamic stiffness; and
an equivalent mass of liquid.

According to the invention, the frequency decoupling device is preferably designed to filter noise in a frequency range of between 180 Hz and 800 Hz while at the same time ensuring sufficient guidance of the parts relative to one another.

To do this, the thickness E of the chamber 5 is defined as a function of the following geometric condition:

$$E \leq \frac{{( {P}_{int} / 2 π )}^{3}}{200000} \times H ,$$

in which Pᵢₙₜ is the interior perimeter of the chamber 5 and H is the mean height of the said chamber on its circumference (both expressed in millimetres). In the embodiments depicted, the thickness E of the chamber 5 is constant, however, were that not to be the case, the thickness E to be considered in the geometric condition would be the mean thickness of the said chamber.

According to this geometric condition, the thickness of the chamber 5 is small enough to obtain a dynamic setting of between 180 Hz and 800 Hz, particularly of around 200 Hz, while at the same time enjoying very substantial static stiffness for guidance. In particular, the thickness E of the liquid chamber 5 may be less than 4 mm, notably between 0.5 mm and 2 mm, and more specifically of the order of 1 millimetre for an average automotive application aimed at a very high degree of comfort.

Moreover, the thickness of the elastically deformable element, namely that of the rings 3, 4, is also small, notably equal to the thickness eₚ of the liquid chamber 5. Thus, it is possible for the elastically deformable element to have no retaining cage like the cage inserted in the deformable part of a conventional hydro-elastic joint. This is because the small relative thickness of the elastically deformable element limits its own deformation and self-retention is therefore sufficient.

By way of example, in the embodiment of FIG. 1, the geometric data are:
height of each ring: 4 mm;
interior perimeter Pᵢₙₜ of the chamber: 195 mm;
height H of the chamber: 40 mm;
thickness E of the chamber: 1 mm.

With these geometric data and with a deformable element made of conventional elastomeric material, the following dynamic characteristics are achieved for the frequency decoupling device:
static stiffness: 30 kN/mm;
dynamic stiffness: 22 kN/mm, giving a very high expansion stiffness;
equivalent mass of liquid: 7 kg;
and therefore a natural frequency of 9 kHz.

Furthermore, from 180 Hz to 330 Hz, the dynamic stiffness is positive and less than 0.7 times the static stiffness, and between 330 Hz and over 800 Hz, the real part of the stiffness is negative.

However, the deflection of such a frequency decoupling device is limited, particularly the linear and torsional deflection. If such deflection is needed in the application, the invention makes provision for combining such a device with another component to make it possible to create a hydro-elastic joint of substantial amplitude. In particular, an joint such as this may form a ball end of a wishbone of a motor vehicle front axle assembly.

FIG. 2 depicts a first embodiment of a hydro-elastic joint comprising a frequency decoupling device, the said device being of a design similar to that described in conjunction with FIG. 1. However, in FIG. 2, the height of the rings 3, 4 is greater and the height of the liquid chamber 5 is therefore correspondingly smaller. In addition, the inner sleeve 2 has an additional thickness facing the chamber 5, which means that the thickness of the said chamber is accordingly reduced.

The joint comprises a rigid member 7 which is positioned inside the inner sleeve 2, the said member being associated with the said sleeve via an elastically deformable body 6.

In one application that has not been depicted, the frequency decoupling device can be used with a rigid member such as the outer race of a rolling bearing, which is then associated with the inner sleeve 2 without the interposition of an elastically deformable body.

In FIG. 2, the rigid member is formed of a ball end 7 the axis of which is the same as that of the sleeves 1, 2, the said ball end comprising a bore 8 allowing it to be combined with the chassis of the motor vehicle. The elastically deformable body 6 is positioned at least around the spherical part of the ball end 7, particularly by overmoulding it onto the said part.

Further, a rigid structure for push-fitting the elastically deformable body 6 inside the inner sleeve 2 is provided at the interface between the said sleeve and the said body. More specifically, the structure comprises a tubular sleeve 9 the edges of which are radially curled inward in order axially to grip the elastically deformable body 6.

A second embodiment of a hydro-elastic joint according to the invention, in which the rigid member 7 is similar to that of FIG. 2, is described in conjunction with FIG. 3.

In this embodiment, the elastically deformable body 6 is directly associated with the inner sleeve 2, particularly by overmoulding. To do this, the inner sleeve 2 consists of the sleeve 9 according to FIG. 2, on the exterior surface of which the two deformable rings 3, 4 are positioned. More specifically, each ring 3, 4 is positioned respectively at the level of the radial bend so as to form the chamber 5 over substantially the entire height of the axial wall of the sleeve 9.

Next, as shown in FIG. 3b, the outer sleeve 1 can be push-fitted over the inner sleeve 2, while at the same time immersing the joint in a bath of liquid in order to fill the chamber 5. In particular, because of the small thickness of the rings 3, 4, this push-fitting is rendered possible even without fitting a retaining cage in the rings 3, 4. Next, the edges of the outer sleeve 1 are bent over onto the rings 3, 4 to improve the sealing of the chamber 5 and the mutual cohesion of the sleeves 1, 2.

FIG. 4 depict a first alternative form of the embodiment of FIG. 3, in which the elastically deformable element further comprises an intermediate ring 10 which, with the upper 3 and lower 4 rings respectively, delimits two spaces in the liquid chamber 5, these respectively being an upper space and a lower space.

Furthermore, the spaces communicate with one another so as to provide axial filtering in addition to the radial filtering. To achieve this, the intermediate ring 10 is discontinuous so as to form substantially axial passages 10a between the said spaces.

FIG. 5 depicts a second alternative form of the embodiment of FIG. 3, in which the upper ring 3 and the lower ring 4 have waves 11 extending inside the liquid chamber 5. According to another embodiment, provision could be made for just one of the rings 3, 4 to have at least one wave 11.

The joint according to FIG. 5 makes it possible to create two frequency settings along the axes X and Y respectively. To achieve this, the upper ring 3 comprises two waves 11 which in this instance are symmetric with respect to a longitudinal plane of the chamber 5, two waves 11 being provided on the lower ring 4, these being positioned facing a respective wave 11 of the upper ring 3. Although the waves 11 depicted have the same geometry, it is conceivable for this geometry and for the respective arrangement of the waves 11 to be modified to suit the requirements of the intended application.

As an alternative that has not been depicted, the two frequency settings along the axes X and Y respectively may be obtained with a liquid chamber 5 of oval cross section.

FIG. 6 depict the assembly of a hydro-elastic joint according to a third embodiment of the invention, in which the upper 3 and lower 4 rings are attached to the inner sleeve 2.

The rigid member is formed of a tube 12 around which the elastically deformable body 6 is overmoulded with the inner sleeve 2, the said sleeve comprising outer peripheral grooves 13 to accept rings 3, 4 respectively. Next, and possibly after the rings 3, 4 have been bonded into their groove 13, the outer sleeve 1 is push-fitted over the inner sleeve 2 while at the same time immersing the joint in a bath of liquid in order to fill the chamber 5. Finally, the edges of the outer sleeve 1 are bent over onto the rings 3, 4. In contrast to the other embodiments in which the rings are overmoulded onto one of the sleeves 1 or 2, the rings in the embodiment of FIGS. 6a to 6c are not overmoulded onto either of the two sleeves but in fact act exactly like independent seals. It may also be seen that the rings in this example are in the form of o-ring seals.

FIG. 7 shows another embodiment in which the rings are produced in two distinct parts, a horizontal part 31 (or 41) and a vertical part 32 (or 42). It will be understood that the axial stiffness of the decoupling device is then determined predominantly by the characteristics of the horizontal parts and that the radial stiffness of the decoupling device is then determined predominantly by the characteristics of the vertical parts. The elastomeric materials of the two parts may also be identical or different.

FIG. 8 depicts an alternative form of the joint of FIG. 3b in which a radial annular stop 14 limits the relative movements of the sleeves 1 and 2 (and therefore the stresses) experienced by the deformable element. The stop 14 may be a simple annulus made of a relatively rigid plastic such as polyamide.

FIG. 9 depicts the principle of a radial stop 15 obtained by a circumferential fold in the internal sleeve 2.

FIG. 10 depicts another embodiment of the joint in which the inner sleeve is formed of a combination of two half-sleeves 21 and 22, for example made of a relatively rigid plastic such as polyamide, which are welded, bonded or clipped together (the outer sleeve 1 is not depicted here).

FIG. 11 depicts an embodiment in which the liquid chamber 5 is formed in an annular deformation 16 of the outer sleeve 1. This simplifies the overmoulding of the deformable element 3.

FIG. 12 depicts an outer sleeve formed of two parts 17 and 18 partially push-fitted one inside the other. This may simplify the assembly of the joint and make it possible to obtain a peripheral flange 19.

FIG. 13 depicts a joint in which the relative movements of the sleeves 1 and 2 are permitted by elastic deformation of flexible regions 101 and 102 of the outer sleeve 1. The rings 33 and 43 maintain their function of sealing the liquid chamber but are no longer necessarily predominant in dictating the elastic characteristics of the decoupling device.

FIG. 14 depicts a cross section through one embodiment of the decoupling device of the invention, in which the chamber 5 (which is preferably cylindrical) has a non-circular cross section.

FIGS. 15 and 16 depict a joint in which the inner sleeve 2 is shaped in such a way that the rings 3 and 4 have a thickness greater than the thickness E of the chamber 5 over a substantial part of their height. In this way, the sealing of the small-thickness chamber is further enhanced by the creation of a thicker seal. FIG. 16 shows the joint fully assembled after immersed push-fitting and the shaping of the edges of the outer sleeve 1.

FIG. 17 depicts a joint in which the inner sleeve 2 is made of a rigid plastic. This in particular allows it to be given a relatively precise shape such as, in this instance, a spherical inner shape which is concentric with the spherical shape of the central part of the rigid member 7 and an outer shape that is similar to the inner sleeve of the embodiment of FIGS. 15 and 16. The elastically deformable body 6 is moulded (and therefore bonded) between the rigid member and the inner sleeve. The rings 3, 4 and the outer sleeve 1 in this example are identical to those of FIG. 16.

The inner sleeve 2 may be moulded as a single piece but as a preference it can be obtained by moulding two half-sleeves which are then welded together, using ultrasonic welding, or, as depicted in FIG. 18, which are clipped together before the elastically deformable body 6 is moulded.

FIG. 19 depicts the schematic half-section of a joint in which the outer sleeve 1 is made of two parts 101 and 102 secured together by an outer shell ring 103. The rings 31, 32, 41, 42 here have the shape described above with reference to FIG. 7. It will be understood that the rings are preferably overmoulded (and therefore bonded) on the corresponding parts 101 and 102 rather than on the inner sleeve 2. The parts 101 and 102 are then axially assembled and therefore grip the rings around the inner sleeve 2. The shell ring 103 is then push-fitted under immersion, in order to close the liquid-filled chamber 5. A first embodiment of the sealing required between the two parts 101 and 102 and which is obtained by virtue of a peripheral seal 104 arising out of the same overmoulding operation as the rings 31 and 32 can be seen here.

FIG. 20 depicts a joint according to an embodiment similar to the embodiment of FIG. 19. This embodiment, however, differs therefrom in that the peripheral seal 104 secured to the upper part 101 collaborates with a peripheral seal 104′ secured to the lower part 102. The parts 101 and 102 in this instance are therefore perfectly identical. This makes it possible further to reduce the cost of manufacture of such an joint.

FIG. 21 depicts a joint in which the rigid member 71 is a ball end slidingly mounted in the inner sleeve 2 made, for example, of rigid plastic such as polyamide or metal. The rings 3 and 4 are overmoulded on the inner sleeve which is shaped in such a way that the rings are thicker than the chamber 5, according to a principle described above with reference to FIGS. 2 and 15.

The inner sleeve 2 may comprise a passage 51 for filling the fluid chamber 5 after the outer sleeve 1 has been push-fitted. Alternatively, the push-fitting operation may naturally be performed immersed in a bath of liquid.

The outer sleeve 1 here is configured to accommodate a protective boot that protects the ball joint and to be secured by screw fastening to a part of the vehicle such as a hub carrier while the shank of the ball joint can be fixed to another part of the vehicle such as a suspension wishbone or suspension arm. A horizontal ring 41 provides the desired axial stiffness.

It will be understood that one feature that is common to all the embodiments of the invention is that the rings are bonded to one of the two sleeves at most, namely the inner sleeve or the outer sleeve, or even are not bonded to either of the two according to the embodiment of FIGS. 6a to 6c.

In general, the invention has been described in the case of joints intended to be mounted within a suspension system, for example at the end of a suspension wishbone or a suspension arm. Naturally, the joint may also be formed directly in such an arm or wishbone, it then being possible for the latter to replace the outer sleeve.

Among the advantages that can be achieved with a hydro-elastic joint according to the invention, mention may be made of:
the fact that a filtering effect can be had on a part that is very stiff, particularly with a stiffness in excess of 10 kN/mm;
a wide filtering band effect, more specifically ranging between 200 Hz and 500 Hz;
asymmetric operation or operation along two axes X and Y;
advantageous industrial cost.

1. A frequency decoupling device for decoupling a first part with respect to a second part, the device comprising a rigid outer sleeve which is adapted to be secured to the first part and, positioned inside the said outer sleeve, a rigid inner sleeve which is adapted to be secured to the second part, an elastically deformable element being interposed between said sleeves so as to form between said sleeves at least one annular chamber containing a liquid, wherein, with the chamber being of a small thickness, the elastically deformable element comprises an upper ring and a lower ring which axially delimit the chamber, respectively forming seals for said chamber.

2. The frequency decoupling device according to claim 1, wherein, with the annular chamber having an interior perimeter “Pᵢₙₜ”, a mean height “H” on the perimeter and a mean thickness “E” on the perimeter, the mean thickness E satisfies the following condition:
$$E \leq \frac{{( {P}_{int} / 2 π )}^{3}}{200000} \times H ,$$
the interior perimeter Pᵢₙₜ, the mean height H and the mean thickness E being expressed in millimetres.

3. The frequency decoupling device according to claim 1, wherein the annular chamber exhibits symmetry of revolution.

4. The frequency decoupling device according to claim 1, wherein the annular chamber is of a cylindrical shape.

5. The frequency decoupling device according to claim 1, wherein the mean thickness E of the chamber is less than 4 mm.

6. The frequency decoupling device according to claim 1, wherein the thickness of the elastically deformable element is equal to the thickness E of the chamber.

7. The frequency decoupling device according to claim 1, wherein the chamber is provided radially facing a respective axial wall of each of the sleeves.

8. The frequency decoupling device according to claim 1, wherein the elastically deformable element further comprises an intermediate ring which, with the upper and lower rings respectively, delimits two spaces in the liquid chamber, said intermediate ring being discontinuous so as to form passages for liquid between the two spaces.

9. The frequency decoupling device according to claim 1, wherein the upper ring and/or the lower ring has at least one wave extending inside the chamber.

10. The frequency decoupling device according to claim 1, wherein the upper ring comprises two waves which are symmetric with respect to a longitudinal plane of the chamber, two waves being provided on the lower ring, these being positioned facing a respective wave of the upper ring.

11. The frequency decoupling device according to claim 1, wherein the chamber has the geometry of a cone with symmetry of revolution.

12. The frequency decoupling device according to claim 1, wherein the elastically deformable element is overmoulded onto the inner sleeve.

13. The frequency decoupling device according to claim 7, wherein the upper and/or lower rings are attached to the inner sleeve.

14. The frequency decoupling device according to claim 1, wherein the volume of the chamber is at least partially formed by a deformation of the outer sleeve.

15. A hydro-elastic joint comprising a frequency decoupling device according to claim 1, comprising a rigid member which is positioned inside the inner sleeve, said member being associated with said sleeve via an elastically deformable body.

16. A hydro-elastic joint comprising a frequency decoupling device according to claim 1, comprising a ball end which is positioned inside the inner sleeve, the said ball end sliding in the inner sleeve.

17. The frequency decoupling device according to claim 5, wherein the mean thickness E of the chamber is between 0.5 mm and 2 mm.
